(19) United States
(12) Patent Application Publication
(10) Pub. No.: US 2002/0172443 A1
(43) Pub. Date: Nov. 21, 2002

(54) Rolling bearing unit

(75) Inventors: Hiromitsu Muraki, Fujisawa-shi (JP); Kenju Takei, Fujisawa-shi (JP); Norihiro Aoki, Fujisawa-shi (JP); Norikazu Kitagawa, Fujisawa-shi (JP)

Correspondence Address: CROWELL & MORING LLP, INTELLECTUAL PROPERTY GROUP, P.O. BOX 14300, WASHINGTON, DC, 20044-4300, US

(73) Assignee: NSK LTD., Fujisawa-shi (JP)

(21) Appl. No.: 10/134,639

(22) Filed: Apr. 30, 2002

(30) Foreign Application Priority Data
May 1, 2001 (JP) 2001-133773
May 7, 2001 (JP) 2001-135968

(51) Int. Cl. F16C 43/00

(52) U.S. Cl. 384/537

(57) ABSTRACT

A rolling bearing unit for a swing arm comprises a pivot, a pair of rolling bearings for rotatably supporting the pivot with respect to a stationary shaft, and an E block for the swing arm connected to the pivot, the E block having ends at least one of which is provided with an axially extending lip section, and the lip section being bent e.g. at three locations to be crimped against the end of the pivot for connection.

### BACKGROUND OF THE INVENTION

1. Field of the Invention

This invention relates to a rolling bearing unit, sometimes referred to as a sleeveless pivot bearing unit, that is used, for example, in a location where there is high-speed minute rocking motion, such as for use in the swing arm of a magnetic disk apparatus.

2. Description of the Related Art

In a prior art rolling bearing unit for a swing arm as shown in FIG. 1 to FIG. 4, a pair of ball bearings 103, 104 with a grease sealed in them are used around a shaft 2 under a specified pre-load. A housing 300 is fixed around the outer peripheral surfaces of the outer races of the ball bearings 103, 104. An E block 200 in which a voice coil motor (VCM) is installed is formed integrally with a swing arm or swing arms and attached to the housing 300. In a conventional rolling bearing unit for a swing arm shown in FIG. 1 to FIG. 4, the left side is the voice coil motor (VCM) side.

FIG. 1 shows a pulling type in which a bolt 400 is screwed into the outer diameter section 301 of a housing 300, which pulls the housing 300 to tightly fasten the housing 300 to the E block 200 that has integrally formed the swing arm(s). The tension force produced in the bolt 400 is utilized to tightly connect the housing 300 to the E block 200. Specifically, in the method for attaching the E block 200 to the housing 300 as shown in FIG. 1, a through hole is formed perpendicular to the axis of the housing 300, and a screw hole is formed in the housing 300 such that it corresponds to the through hole. By screwing the bolt 400 into this screw hole, the E block 200 and housing 300 are fastened together.

FIG. 2 shows a pushing type in which a bolt 400 pushes the outer-diameter section 301 of the housing 300, which tightly fastens the housing 300 to the E block 200. The compression force produced in the bolt is utilized to tightly connect the housing 300 to the E block 200. Specifically, a screw hole is formed perpendicular to the axis of the housing 300, and by screwing in the bolt 400 into this screw hole such that the tip of the bolt 400 pushes the housing 300, the E block 200 is fastened to the housing 300.

FIG. 3 shows a type in which the outer-diameter side 301 of the housing 300 is adhesion-fixed to the inner peripheral surface of the E block 200. An adhesive is used to tightly connect the housing 300 to the E block 200. Specifically, the outer peripheral surface of the housing 300 is attached to the inner peripheral surface of the E block 200 with an adhesive.

In the case of this prior bearing unit for swing arm based on FIG. 3, a pre-load is applied to two ball bearings in which the grease is sealed In this prior art, an adhesive is applied to a total of four locations: on radially inner surfaces of the inner races and on the radially outer surfaces of the outer races, and they are attached to the shaft 2 and housing 300, or they are attached by pressure fitting without the use of an adhesive. Also, an adhesive is applied to the radially outer surface 301 of the housing 300 of the rolling bearing unit that is assembled as described above.

FIG. 4 shows a type in which a pressure-fitting ring 500 made of wave-shaped steel sheet is fitted around the outer-diameter side 301 of the housing 300, and where this press-fitting ring 500 is pressure fitted with the E block 200. The wave-shaped steel sheet is used to tightly connect the housing 300 to the E block 200. Specifically, a pressure fitting ring 500 made of wave-shaped steel sheet is attached around the outer periphery of the housing 300, and by inserting the outer periphery of this wave-shaped steel pressure-fitting ring 500 into the inner-diameter side 201 of the E block 200, the E block 200 is fastened to the housing 300 by the elastic force of the wave-shaped steel pressure-fitting ring 500.

Recently, there is an increasing demand for higher density magnetic disk devices. In order to accomplish this, the track width on which signals are recorded on the disk have become increasingly more narrow, and there is a demand that the swing arm(s) installed in the head for reproducing the signals be capable of accessing the target track at high-speed and with highly precise positioning. Also, in order to satisfy the demand for high-speed and high-precision control, there is a demand that the rolling bearing unit that supports the swing arm have high rigidity. Furthermore, in order to satisfy the demand for high-speed and high-precision control, the change in rigidity should be small.

However, as shown in FIG. 1, the E block 200 formed with the swing arm(s) pulls the housing 300 via the bolt 400 toward the E block 200 side at one location in the center of the outer-diameter side 301 of the housing 300, and they are connected through contact between the housing 300 and E block 200, where two-point contact in the axial direction occurs due to deformation etc. caused by the connection force between the outer-diameter side 301 of the housing 300 and the inner peripheral surface 201 of the E block 200 by way of the bolt 400, and there are differences in the span between the two points. Particularly, when the span between the two points is short, the moment rigidity became low, and resulted in worsening the resonance of the swing arm, or in other words in worsening the positioning performance. Also, in the case of the pushing type as shown in FIG. 2, there was improvement of the problems mentioned above, however, the same problems still remained.

In the case of the adhesion-fixing type shown in FIG. 3, there is also the problem of outgas in addition to the problems mentioned above. Furthermore, in the case shown in FIG. 4, cost increases due to the increase in the number of parts, and there is a problem of contamination due to friction that occurs when making the pressure fit.

In the prior art rolling-bearing unit for the swing arm, in order to lower the cost, the housing 300 is removed and a spacer is placed between the two outer races, and adhesive is applied to the radially outer surfaces of the outer races and the spacer and those surfaces are attached to the E block 200 in which the voice coil motor (VCM) is installed.

However, when attaching the outer races and spacer to the E block 200 in this way, there is a problem in that when the adhesive hardened it shrunk, which caused large forces to act on the outer races and spacers of the bearing and caused the bearing and spacers to tilt and the pre-load to change.

In addition, in the prior art construction of fastening the E block 200 having the swing arm(s) to the housing 300 using the bolt 400, adhesive or wave-shaped steel pressure-fitting ring, the following problems occurred.

That is, since the E block 200 is manufactured using a die cast, there is the problem that it is very difficult to make the block thinner, more compact or lighter.

Also, in the attachment methods of using the bolt 400 or wave-shaped steel pressure-fitting ring, the number of parts increase and assembly becomes more complicated, so it is easy for variation in precision of the product to occur, and it is also very difficult to reduce the manufacturing cost.

There are also demands to make the apparatus thinner in order to make it possible to reduce the number of disks while maintaining a specified capacity.

The prior art apparatus is limited in its capability to meet the demand to provide an apparatus that is more compact as well as has more stable precision through reducing variation in product variation.

Furthermore, in the case of attachment by adhesive, there is the possibility of a problem with outgas.

### SUMMARY OF THE INVENTION

Taking the above problems with the prior art into consideration, an object of this invention is to provide a rolling bearing unit that has a stable moment rigidity, or in other words stable resonance point, and in which there is no change in the span between contact points due to deformation.

Another object of this invention is to provide a rolling bearing unit having simple and low-cost construction that is able to keep variation in product quality to a minimum and which makes it possible for compact, lightweight and thin construction.

Another object of this invention is to provide a low-cost rolling bearing unit for a swing arm that does not use the housing, and in which the pre-loading does not change and the rigidity changes very little even when external forces act on the rolling bearing unit.

### BRIEF DESCRIPTION OF THE DRAWINGS

FIG. 1 is a vertical cross sectional view of an example of the prior art rolling bearing unit of the pulling type where a bolt is used for fixing.

FIG. 2 is a vertical cross sectional view of another example of the prior art rolling bearing unit of the pushing type where a bolt is used for fixing.

FIG. 3 is a vertical cross sectional view of another example of the prior art rolling bearing unit where the adhesion is used for fixing,

FIG. 4 is a vertical cross sectional view of another example of the prior art rolling bearing unit where the pressure-fitting ring is used for fixing.

FIG. 5 is a vertical cross sectional view of a first embodiment of the rolling bearing unit according to the present invention.

FIG. 6 is an enlarged view of a main portion of FIG. 5.

FIG. 7 is an enlarged view of another main portion of FIG. 5.

FIG. 8 is an enlarged view of another main portion of FIG. 5.

FIG. 9 is a vertical cross sectional view of a second embodiment of the rolling bearing unit according to the present invention.

FIG. 10 is a vertical cross sectional view of a third embodiment of the rolling bearing unit according to the present invention.

FIG. 11 is a cross sectional view of a fourth embodiment of the rolling bearing unit, which is used for the swing arm.

FIG. 12 is a cross sectional view of a fifth embodiment of the rolling bearing unit, which is used for the swing arm.

FIG. 13 is a vertical cross sectional view of a sixth embodiment of the rolling bearing unit according to the present invention.

FIG. 14 is a partly (left side) vertical cross sectional and partly (right side) side elevational view of a seventh embodiment of the rolling bearing unit according to the present invention.

FIG. 15 is a vertical cross sectional view of an eighth embodiment of the rolling bearing unit according to the present invention.

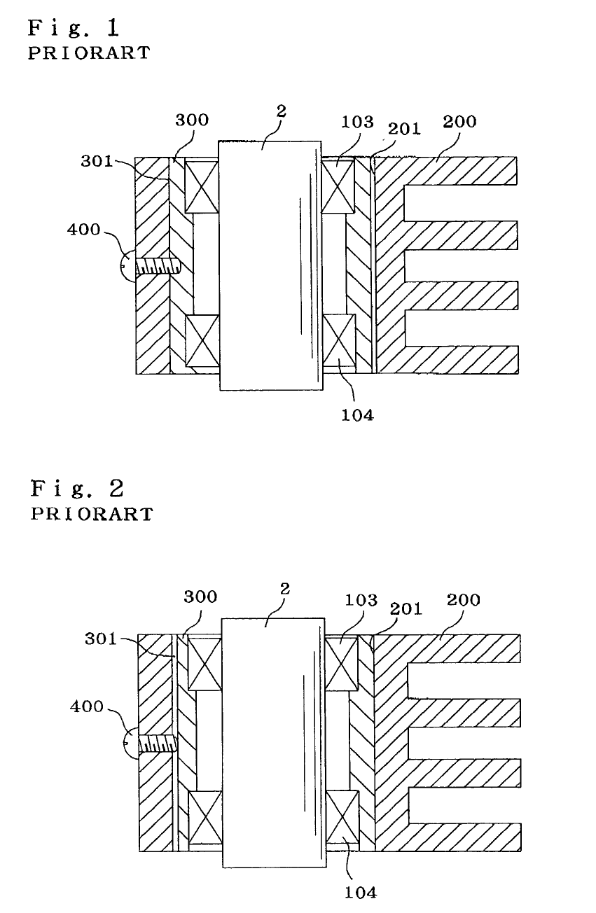

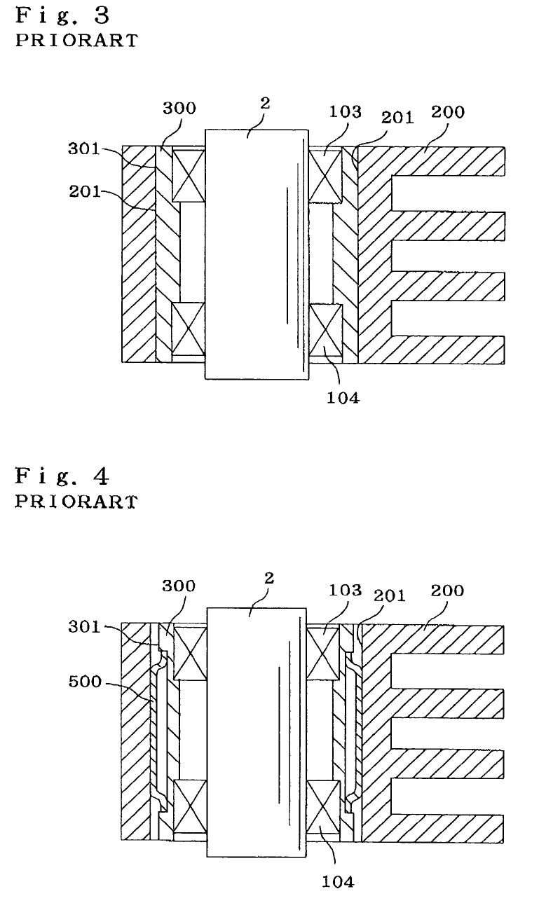

### DETAILED DESCRIPTION OF THE PREFERRED EMBODIMENTS

The preferred embodiments of the rolling bearing unit of this invention are explained below based on the drawings.

The preferred embodiments are examples used for explaining the rolling bearing unit of the invention, however, the invention is not limited to these embodiments, and other appropriate forms that are within the range of the invention can be selected.

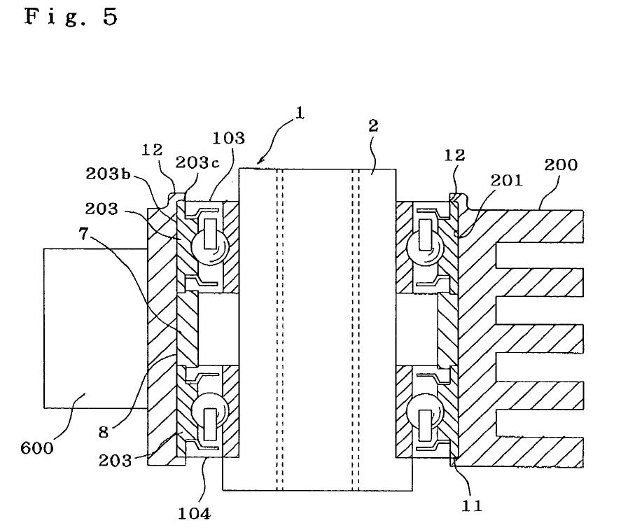

In order to accomplish the aforementioned objectives of the invention, in a feature of the present invention as shown in FIG. 5 to FIG. 10, an E block 200 is connected to a pivot 1 that is supported by rolling bearings such that it is capable of rotating with respect to a stationary shaft 2, and that E block 200 has a lip section 12 on at least one of its ends that protrudes outward in the axial direction, and that the lip section 12 is bent in at least three locations and tightly crimped in order to connect it to the end of the pivot 1.

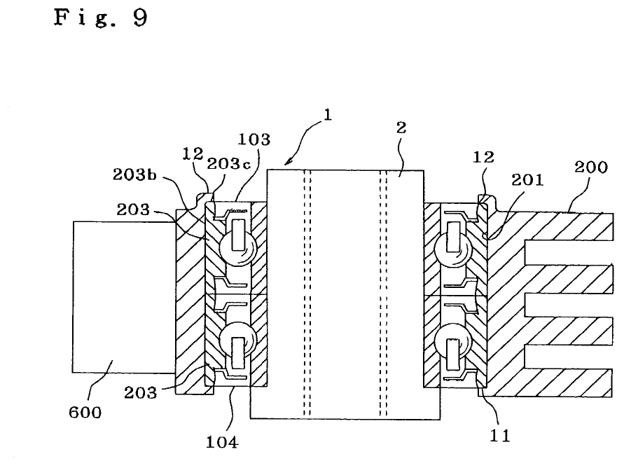

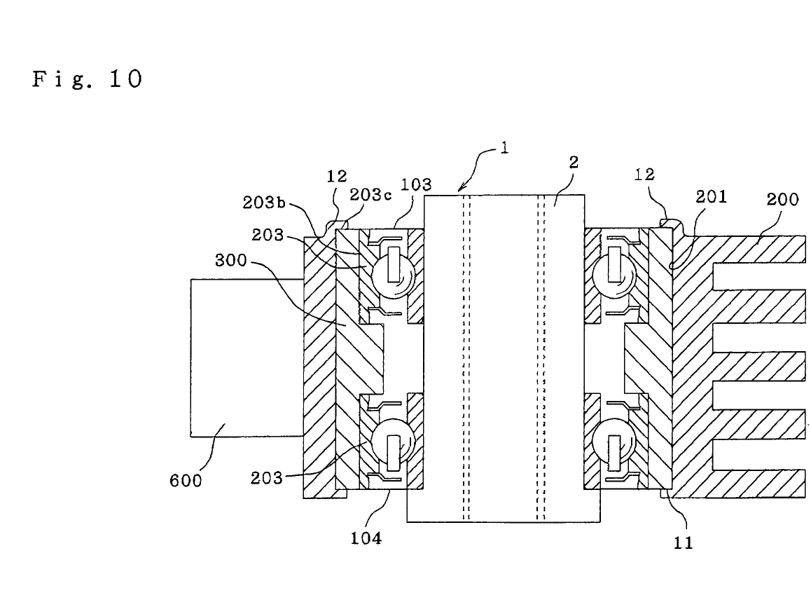

FIG. 5 shows a first embodiment, FIG. 9 shows a second embodiment and FIG. 10 shows a third embodiment, and each of the embodiments is a rolling bearing unit for a swing arm of a magnetic disk apparatus, such as a hard disk drive (HDD), in which an E block 200 for the swing arm(s) is supported by a pivot 1 such that it can rotate, and the voice-coil motor (VCM) 600 is located on the left side in the figures.

In regards to the pivot 1 in FIG. 5, upper and lower rolling bearings (ball bearings) 103, 104 are attached to the shaft 2 with adhesive or by pressure fitting, and there is a spacer 7 between the pair of outer races 203.

The outer diameter 8 of the spacer 7 is less than the outer diameter 203b of the outer race 203, and there is a very small clearance between the outer diameter 203b of the outer race 203 and the inner diameter 201 of the E block 200.

The construction of the upper and lower rolling bearings 103, 104 and the spacer 7 are not specially limited by the embodiment and an arbitrary design is possible.

The E block 200 has an inner-diameter stepped section 11 on the bottom, and the outer race 203 of the lower bearing 104 of the pivot 1 protrudes out and comes in contact with the inner-diameter stepped section 11.

There is a plurality of lip sections 12 on the top end of the E block 200 that extend in the axial direction.

The material of the E block 200 is not particularly limited, however, an aluminum alloy that bends easily is a typical example.

The lip sections 12 extend a desired length in the axial direction from the top end of the E block 200, and the lip sections 12 are formed at desired intervals around in the circumferential direction.

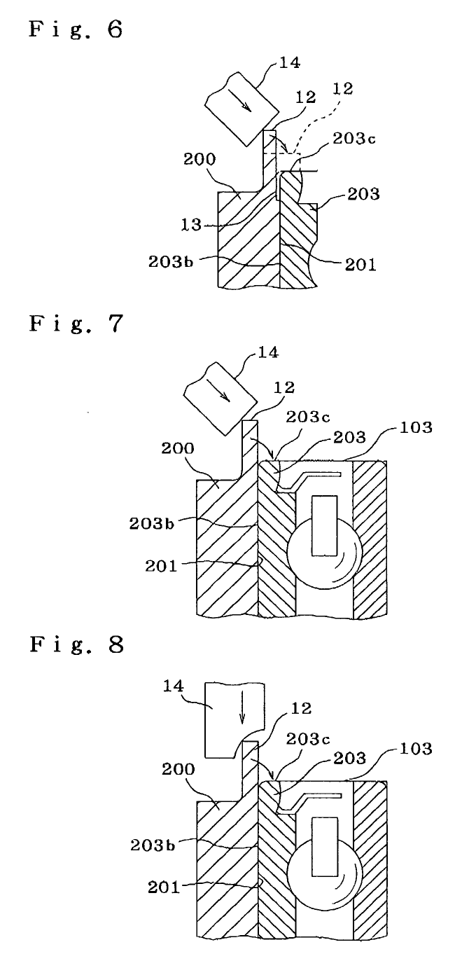

Several of the lip sections 12 are bent inward toward the inner diameter 201 of the E block 200 by a die 14, such that they push against the end (pivot end) 6 of the outer race 203 (see FIG. 6 and FIG. 7).

In order to keep the outer race 203 from deforming, it is preferred that a relief space 13 be formed (see FIG. 6).

As to the connection by way of crimping, in order that the bending force required when performing crimping is not too large, it is preferred that at least three locations on the lip sections 12 be crimped.

Also, it is preferred that the thickness in the radial direction of the lip sections 12 be 0.2 to 2 mm. When the thickness is greater than 2 mm, the bending force required during crimping becomes large and causes the outer race to deform, In other words it causes the outer race grooves to deform and causes changes in torque.

The amount that the lip sections 12 protrude in the axial direction and the number of crimped connection locations should be designed such that the pivot 1 is not separated from the E block 200 due to impact during crimping for connection (partial crimping).

In this embodiment, together with crimping the lip sections 12 that are formed on the top end of the E block 200, the outer race 203 of the lower bearing 104 of the pivot 1 is supported by a stepped section 11 that is formed on the bottom end of the E block 200, however, it is also possible to form a stepped section 11 on the top of the E block 200 and to crimp lip sections 12 for crimping that are formed on the bottom of the E block 200. Also, forming lip sections 12 on both ends of the E block 200 to perform crimped connections is also within the range of this invention,

Also, in order to make a uniform crimped connection, it is within the range of this invention to form a single lip section 12 all the way around the entire circumference and to perform crimping all the way around the circumference. An example of performing crimping all the way around the circumference is shown in FIG. 8, however, except for construction where the lip section 12 is formed all the way around the circumference, this is substantially the same as the case of partial crimping, so the like code numbers are used for the like locations, and an explanation is omitted

Moreover, even in the case of performing crimping all the way around the circumference, it is possible to form the lip section 12 on both the top and bottom ends to perform crimped connection.

Construction that uses a relief space 13 shown in FIG. 6 for suppressing deformation of the outer race is also used.

With construction of this embodiment, low cost is achieved by not having a housing and by reducing the number of parts.

As mentioned above, by forming the lip sections 12 on at least one end of the E block 200 to protrude in the axial direction, and bending the lip sections 12 in at least three locations to crimp them around the end 203c of the outer race 203, it is possible to reduce variation in rigidity (resonance) and to increase the moment rigidity.

Also since the E block 200 is fastened to both ends in the axial direction of the pivot 1, it is possible to reduce tilting of the rolling bearing, and decrease changes in torque. In addition, the amount of outgas can be reduced because no adhesive is used.

In the second embodiment in FIG. 9, a spacer 7 is not used between the outer races 203 as in the first embodiment, but rather the top and bottom outer races 203 come in direct contact with each other (see FIG. 9), where they are narrower than the width of the inner races to apply a pre-load to the rolling bearing.

The other construction and effects of this embodiment are the same as those of the first embodiment.

In the third embodiment in FIG. 10, the housing 300 is formed around the outer-diameter section 5 of the outer races 203, and the lip sections 12 of the E block 200 are crimped around and fastened to the end (pivot end) of the housing 300 (see FIG. 10).

The housing 300 can be of any suitable, well known type, and the invention is not particularly limited by the illustrated one.

The other construction and effects of this embodiment are substantially the same as those of the first embodiment.

In the construction as described above, substantially no variation is caused in the contact span, and it is capable of preventing a decrease and variation in the rigidity (resonance) and moment rigidity, and improving the positioning function and precision, and since there is no need to process a bolt surface or to use a bolt or pressure-fitting ring made of wave-shaped steel sheet, the production cost is decreased.

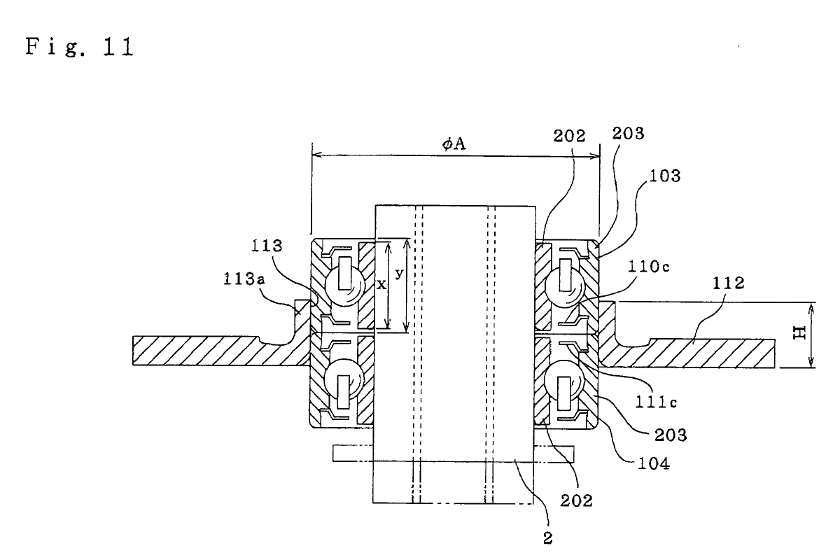

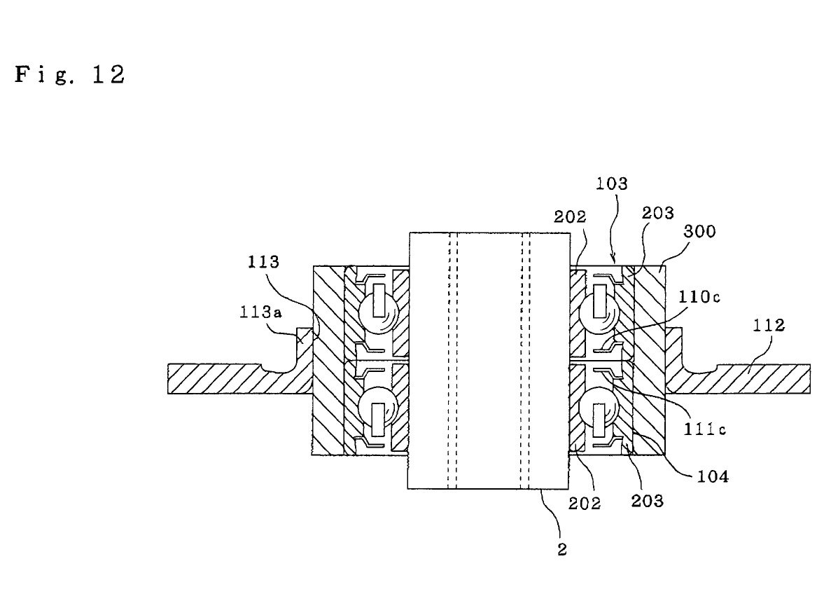

In aother embodiment of this invention as shown in FIGS. 11 and 12, where the left side is the VCM side and the right side is the head side, the bearings 103, 104 are installed around the shaft 2, and a rotating member 112 having a hole 113 with an opening is formed by press processing.

The rotating member 112 is supported by way of the hole 113 such that it can rotate freely via the rolling bearings 103, 104 around the shaft 2.

By using the hole 113 opened by press processing in the rotating member 112, the rotating member 112 is supported such that it can rotate freely around the shaft 2, construction is simpler and lower cost than the prior construction, as well as it is possible to suppress variation in product quality and to make the rolling bearing unit more compact, lightweight and thinner. Moreover, since it is possible to do away with screw processing and the use of a bolt or pressure-fitting ring made of wave-shaped steel sheet, it is possible to reduce the number of parts and assembly steps, and thus further reduce the cost of the apparatus. Furthermore, it is possible to avoid the problem of outgas.

The hole 113 can be formed by a burring process such that it has a flange section 113a, and with this construction, it is possible to suppress variation in the product quality when supporting the rotating member 112 around the shaft 2 using the hole 113.

Specifically, FIG. 11 shows a bearing unit for a swing arm of a fourth embodiment of the invention. The overall construction is similar to that of the prior art apparatus shown in FIG. 5 and FIG. 6.

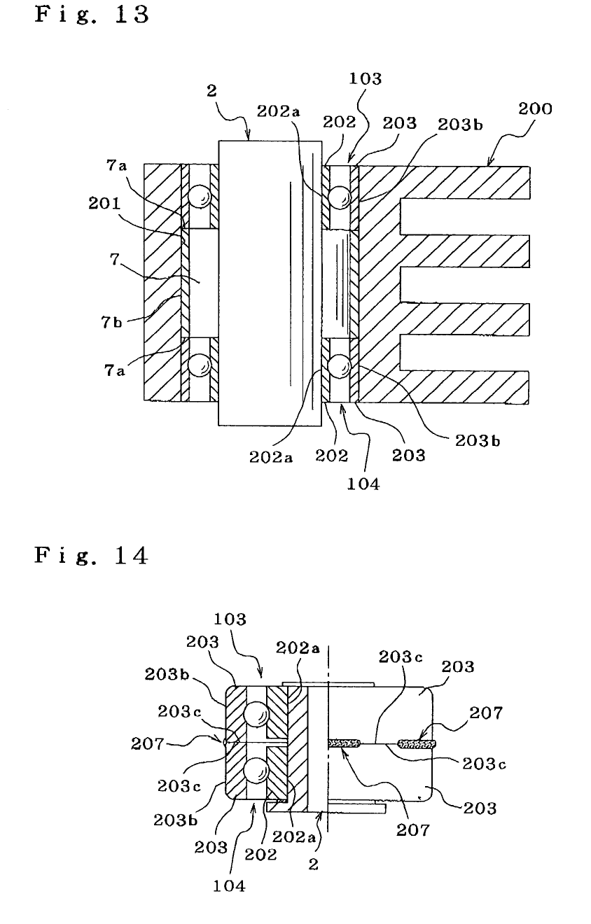

In FIG. 11, the inner races 202 of the pair of ball bearings 103, 104 are fitted around and fixed to the outer peripheral surface of the shaft 2 by way of adhesion or pressure fitting. In this embodiment, the width X in the axial direction of the inner races 202 of the pair of ball bearings 103, 104, is less than the width Y in the axial direction of the outer races 203 of the pair of ball bearings 103, 104, and the end surfaces in the axial direction of the outer races 203 come in direct contact with each other. By bringing the inner races 202 very near to each other with the outer races 203 in contact and fastening the inner races 202 to the shaft 2, it is possible to apply a specified pre-load to the ball bearings 103, 104. In other words, in the example shown in FIG. 13 of this embodiment, there is no spacer placed between the inner races (or outer races) of the pair of ball bearings for relative positioning in the axial direction of the inner races (or outer races).

With this construction of having no spacer, it is possible to reduce the number of parts as well as the number of assembly steps, and thus it possible to lower the cost.

In this embodiment, the rotating member 112 functions as the swing arm is constructed using a single flat plate, and the flange hole 113 is formed by press processing (burring processing; a plastic processing technique of punching out the material with a conical or cylindrical punch (die) to form a flange). As shown in FIG. 11, the flange section 113a of the hole 113 is shaped such that it overlies the area of contact between the outer races 203, and the hole 113 with the flange section 113a is pressure fitted onto the outer diameter section of the outer races 203.

In order for burring to be suitable, it is preferred that the flange height be H≦φA/4.

In this embodiment, the E block 200 used in the prior art construction is done away with, and the swing arm or rotating member 112 is constructed from a single flat sheet and the outer-diameter sections of the outer races 203 are pressure fitted directly in the hole 113 formed by press processing, so the construction is simple and low cost, and it is possible to suppress variation in product quality while at the same time make the apparatus more compact, lightweight and thinner. Also, by reducing the number of parts it is possible to further reduce the apparatus cost. In addition, it is possible to keep the problem of outgas due to the use of adhesive to a minimum.

It is preferred that the material used for the swing arm 112 be an aluminum alloy that can be bent easily. Also, it is possible to use a metal such as steel, copper or titanium that have a high bending strength.

Furthermore, in order to simplify installation in the base section of the shaft 2, it is possible to form a flange section on the lower portion of the shaft 2 as shown by the dotted line in FIG. 11.

Moreover, in the case where outgas resulting from the use of adhesive would not be a particular problem (in the case of improved adhesive or other countermeasures), it is possible to attach the flanged hole 113 around the outer-diameter sections of the outer races 203 using adhesive.

FIG. 12 shows a fifth embodiment of the invention. The like code numbers will be used for elements that are substantially identical to those in the fourth embodiment.

As shown in FIG. 12, in the case of the rolling bearing unit for a swing arm of this embodiment, the housing 300 is formed around the outer-diameter section 203b of the outer races 203 of the pair of ball bearings 103, 104, and the hole 113 is formed in the swing arm or rotating member 112 with a flange section 113a that is made by pressing (burring), so that the outer-diameter section 301 of the housing 300 is fastened (by adhesive or pressure fitting) to the hole 113.

Similar to the first embodiment, in this embodiment, the width in the axial direction of the inner races 202 of the pair of ball bearings 103, 104 is made to be less than the width in the axial direction of the outer races 203 of the pair of ball bearings 103, 104, so that it is possible to apply a specified pre-load to the ball bearings 103, 104 by bringing the end surfaces in the axial direction of the outer races 203 in direct contact with each other. For example, it is possible to apply a pre-load to the ball bearings 103, 104 by placing an outer-race spacer between the outer races 203, or it is also possible to form a stepped section on the inner-diameter section of the housing 300 that functions as an outer-race spacer and to arrange the ball bearings 103, 104 such that the stepped section is sandwiched between the outer races 203.

Similar to the fourth embodiment in FIG. 11, in the fifth embodiment as well, the E block 200 of the prior art construction is done away with, and the swing arm or rotating member 112 is made of a single flat plate in which the hole 113 is formed by pressing, and that the outer-diameter section 301 of the housing 300 is pressure-fitted into the hole 113, so the construction is simple and low cost, and it is possible to suppress variation in the product quality as well as make the apparatus more compact, lightweight and thinner, and to further lower the cost by reducing the number of parts, Also, it is possible to keep the problem with outgas resulting from using adhesive to a minimum.

In the embodiments described in FIG. 11 and FIG. 12 above, the ball bearings 103, 104 have inner seals 110c, 111c, however, in order to lower cost, it is possible to omit these inner seals 110c, 111c.

Moreover, in the aforementioned embodiments, an explanation was given of the rolling bearing unit for a swing arm, however the invention is not limited to this. Also, the hole 113 with flange can be a simple hole formed by pressing with no flange. The hole is also not limited to having a cylindrical shape as seen in the axial direction, but can also be elliptical shaped or polygon shaped.

Furthermore, in the embodiments described above, a pair of ball bearings was used, however, the invention is not limited to this, and can be applied to connecting the outer race of a single ball bearing to a hole formed by pressing in the rotating member (including the case of using the housing 114).

As explained above, the rolling bearing unit of this invention uses a hole formed in the rotating member by pressing, to support the rotating member such that it can rotate freely around the shaft via the rolling bearing. Therefore, compared to the prior construction, the construction is simpler and low cost, and it is capable of suppressing variation in the product quality as well as make the apparatus more compact, lightweight and thinner. Also, since it is possible to do away with screw processing and bolt, or pressure-fitting ring made of wave-shaped steel sheet, it is possible to reduce the number of parts and assembly steps, and thus it is possible to further lower the cost. Furthermore, it is possible to avoid the problem of outgas.

Next, another embodiment of the invention will be explained referring to FIG. 13 and FIG. 14 where the left side is the VCM side. This embodiment is of a rolling bearing unit for a swing arm in which two rolling bearings 103, 104 (FIG. 14) or two rolling bearings 103, 104 and a spacer 7 (FIG. 13) are fastened to the shaft 2 on the radially inside of the swing arm without the use of a housing, where the two rolling bearings 103, 104 are assembled around the shaft 2 with a pre-load applied in the axial direction and where the outer races 203 are fixed to each other or the outer race 203 of at least one of the rolling bearings and the spacer 7 located between the two rolling bearings are fixed to each other using adhesive or a mechanical connection.

The mechanical connection is made for example by pressure fitting one end of the spacer 7 with the inner-diameter surface of the outer race 203, or by screwing the spacer 7 and outer race 203 together.

In this embodiment in FIG. 13, a pre-load in the axial direction is applied to two grease-sealed ball bearings 103, 104 that are assembled around a shaft (fixed shaft) 2, and adhesive is applied at two locations on the inner-diameter surfaces 202a of the inner races 202 to fix the inner races 202 to the shaft 2.

The spacer 7 is placed between the outer races 203 of the two ball bearings 103, 104 and adhesive is applied to the surfaces on both ends of the spacer 7 to be fixed to the two outer races 203.

Rolling bearings 103, 104, spacer 7 and shaft 2 are selected to have optimum for the intended use, and since they are not particularly specified, they are simplified in the drawing. The material used for the bearings 103, 104, for example, is stainless steel or bearing steel, and the material used for the spacer 7, for example, is stainless steel although the above items are not particularly specified. Also, adhesive can be applied to at least one end surface 7a of the spacer 7 to fasten it to one of the races 203, and in this way the spacer 7 is fastened to at least one of the outer races 203.

The position in the radial direction of the spacer 7 is not particularly specified, however, a stepped section (not shown in the figure) is formed on at least one end surface 7a of the spacer 7, and this stepped section can be placed inside a seal groove that is formed on the outer race 203. The stepped section can be formed into a continuous or non-continuous ring shape around the circumference.

Also, in the embodiment it is explained that the shaft 2 is fastened to the inner races 202 with adhesive, however, fastening them by pressure fitting is also within the range of the invention.

The connection of the outer races 203 and the spacer 7 by adhesive can be performed after the shaft 2 and spacer 7 have been assembled and a pre-load in the axial direction has been applied to the bearings 103, 104.

When the rolling bearing unit of this embodiment is fastened to the E block 200 for swing arm of a magnetic disk device such as a hard disk drive (HDD) that is supported such that it rotates freely around the shaft 2, adhesive is applied to the outer-diameter surface 203b of the outer races 203, and the outer-diameter surface 7b of the spacer 7, and they are directly fastened to the inner-diameter surface 201a of E block 200 without the use of the housing 300. Also, the E block 200 is not limited to the form shown in the drawing, and the design can be changed within the range of the invention.

FIG. 14 shows a seventh embodiment of the invention. This embodiment is one form of fastening the outer races 203 of the two ball bearings 103, 104 together with no spacer between the outer races 203, and in this embodiment, the end surfaces 203c of the outer races 203 are fastened together. The adhesion connection is not limited to the adhesive bond 207 as shown in FIG. 14 and its design can be changed within the range of the invention. The other construction is substantially the same as that of the first embodiment and any redundant explanation is omitted.

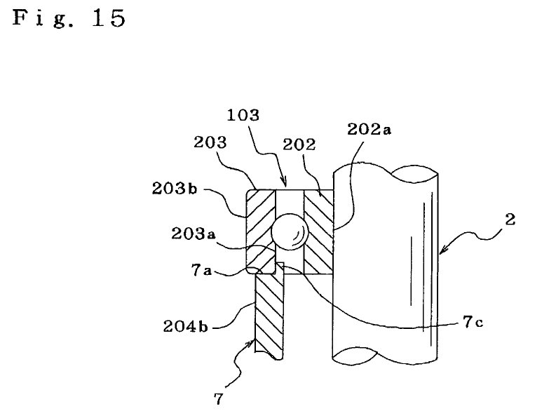

FIG. 15 shows an eighth embodiment of the invention. Similar to the sixth embodiment, in this embodiment, the spacer 7 is placed between the outer races 203 of the two ball bearings 103, 104, however, in this embodiment the spacer 7 is fastened to the outer races 203 by way of a mechanical connection instead of using adhesive.

In this embodiment, the spacer 7 is fastened by pressure fitting with the inner-diameter surfaces 203a of the outer races 203. For example, as an explanation of one form of mechanical connection, in this embodiment a protruding stepped sections 7c are formed on both ends 7a of the spacer 7, and the outer races 203 are fastened to the spacer 7 by pressure fitting the stepped sections 7c with the inner-diameter surfaces 203a of the outer races 203. The stepped section 7c can be formed into a continuous or non-continuous ring shape around the circumference.

It is also possible to select other construction that is within the range of this invention as the method of mechanical connection, for example, it is possible to form a screw groove on the inner-diameter surface 203a of the outer race 203 and the stepped section 7c of the spacer 7, and connect them by screwing them together.

The other construction is substantially the same as that of the first embodiment and any redundant explanation is omitted.

This invention, constructed as described above, provides a low-cost rolling bearing unit for a swing arm that does not use a housing, and since it is capable of reducing change in rigidity without changing the pre-loading, even when external forces act on the bearing, it is capable of satisfying the demands for higher-speed and higher precision of positioning control.

What is claimed is:

1. A rolling bearing unit comprising a pivot having an end, a rolling bearing for rotatably supporting the pivot with respect to a stationary shaft, and an E block connected to the pivot, the E block having ends at least one of which is provided with an axially extending lip section, and the lip section being bent at at least three locations to be crimped against the end of the pivot for connection.

2. A rolling bearing unit comprising a rolling bearing to be mounted onto a shaft, and a rotating member having a hole formed by way of a pressing process, such that the rolling bearing is fitted into the hole to rotatably support the rotating member with respect to the shaft through the rolling bearing.

3. A rolling bearing unit of claim 2, wherein the hole is provided with a flanged portion formed through a burring process.

4. A rolling bearing unit for use between a swing arm and a shaft, comprising a pair of rolling bearings each having an outer race and fixed to the shaft under a preload in the axial direction, the swing arm having an inner periphery and the pair of rolling bearings fixed directly to the inner periphery of the swing arm, the outer races of the pair of rolling bearings being fixed to each other under the preload in the axial direction on the pair of the rolling bearings.

5. A rolling bearing unit of claim 4, wherein the outer races are fixed to each other through one of adhesion and mechanical connection.

6. A rolling bearing unit for use between a swing arm and a shaft, comprising a pair of rolling bearings each having an outer race and a spacer provided between the outer races, and the pair of rolling bearings fixed to the shaft under a preload in the axial direction, the swing arm having an inner periphery and the pair of rolling bearings and the spacers fixed directly to the inner periphery of the swing arm, the spacer being fixed to at least one of the outer races under the preload in the axial direction on the pair of the rolling bearings.

7. A rolling bearing unit of claim 6, wherein the spacer is fixed to the at least one of the outer races through one of adhesion and mechanical connection.

8. A rolling bearing unit of claim 7, wherein the outer race has an inner periphery, and wherein the spacer has one end pressure-fitted into the inner periphery of the outer race for connection.

9. A rolling bearing unit of claim 7, wherein the spacer and the at least one of the outer races have a threaded portion and wherein the spacer is fixed to the at least one of the outer races through screwing connection of the threaded portions.
